(19) United States
(12) Patent Application Publication
(10) Pub. No.: US 2014/0164523 A1
(43) Pub. Date: Jun. 12, 2014

(54) AUTOMATED ENABLING OF INSTANT MESSAGING COMMUNICATIONS IN A CLIENT SYSTEM

(71) Applicant: INTERNATIONAL BUSINESS MACHINES CORPORATION, Armonk, NY (US)

(72) Inventors: JUDITH H. BANK, MORRISVILLE, NC (US); LISA M.W. BRADLEY, CARY, NC (US); LIN SUN, MORRISVILLE, NC (US)

(73) Assignee: INTERNATIONAL BUSINESS MACHINES CORPORATION, ARMONK, NY (US)

(21) Appl. No.: 13/706,632

(22) Filed: Dec. 6, 2012

(51) Int. Cl. H04L 12/58

(52) U.S. Cl. CPC H04L 51/046
USPC 709/206

(57) ABSTRACT

Communicating using an instant messaging client includes detecting an auto-start event for an instant messaging client, wherein the instant messaging client is disabled and associated with a target user, and enabling, using a processor, the instant messaging client responsive to detecting the auto-start event. A list of users permitted to contact the target user through the instant messaging client is updated responsive to enabling the instant messaging client from the auto-start event.

### BACKGROUND

Instant messaging has become ubiquitous. Users engage in conversations using instant messaging technology through a variety of different types of instant messaging clients such as computers, mobile devices, and the like. At times, the volume of instant messages a user receives can become overwhelming. In consequence, a user may choose to close or exit an instant messaging application to avoid interrupts from the large number of instant messages typically received. Such is often the case when a user is under strict time constraints to complete an urgent task. Having completed the task, the user may not recall that instant messaging functionality remains disabled.

### BRIEF SUMMARY

A method includes detecting an auto-start event for an instant messaging client, wherein the instant messaging client is disabled and associated with a target user, and enabling, using a processor, the instant messaging client responsive to detecting the auto-start event. The method further includes updating a list of users permitted to contact the target user through the instant messaging client responsive to enabling the instant messaging client from the auto-start event.

A system includes a processor programmed to initiate executable operations. The operations include detecting an auto-start event for an instant messaging client, wherein the instant messaging client is disabled and associated with a target user, and enabling, using a processor, the instant messaging client responsive to detecting the auto-start event. The operations further include updating a list of users permitted to contact the target user through the instant messaging client responsive to enabling the instant messaging client from the auto-start event.

A computer program product includes a computer readable storage medium having program code stored thereon. The program code is executable by a processor to perform a method. The method detecting an auto-start event for an instant messaging client, wherein the instant messaging client is disabled and associated with a target user, and enabling, using a processor, the instant messaging client responsive to detecting the auto-start event. The method further includes updating a list of users permitted to contact the target user through the instant messaging client responsive to enabling the instant messaging client from the auto-start event.

### BRIEF DESCRIPTION OF THE SEVERAL VIEWS OF THE DRAWINGS

FIG. 1 is a block diagram illustrating an example of a communication system.

FIG. 2 is a block diagram illustrating an example of an instant messaging client.

FIG. 3 is a flow chart illustrating an exemplary method of communicating using instant messaging technology.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustration and/or block diagrams, and combinations of blocks in the flowchart illustration and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

One or more embodiments disclosed within this specification relate to instant messaging (IM) technology and, more particularly, to automatically enabling IM communications for an IM client system. In accordance with the inventive arrangements disclosed within this specification, an IM application can be automatically launched and/or a user, referred to as the “target user,” can be automatically logged into the IM application. These actions can be performed responsive to a detected auto-start event. The auto-start even is indicative of another user, referred to as a source user, expressing a desire to communicate with the target user by way of one or more enumerated communication channels. The IM client system is enabled by launching the IM application and/or logging the target user into the IM application within the IM client system. The IM client system is enabled in a state in which only one or more particular, or designated, users are permitted to contact the target user via the IM client system.

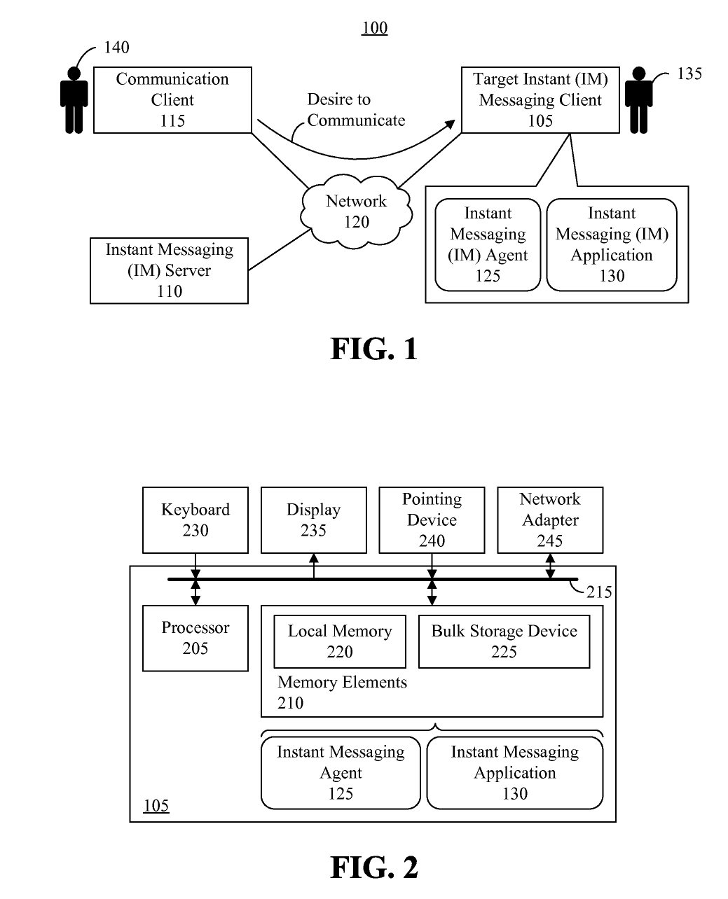

FIG. 1 is a block diagram illustrating an example of a communication system 100. Communication system 100 includes a target IM client 105, an IM server 110, and a communication client 115. Each of target IM client 105, IM server 110, and communication client 115 is communicatively linked through a network 120. Network 120 can be implemented as, or include, any of a variety of different networks such as a WAN, a LAN, a wireless network, a mobile network, a Virtual Private Network (VPN), the Internet, or the like.

Target IM client 105, IM server 110, and communication client 115 each is implemented as a data processing system. Each of target IM client 105, IM server 110, and communication client 115 can be implemented with any of a variety of different form factors. Examples of target IM client 105 and/or communication client 115 include, but are not limited to, a desktop computer, a laptop or other portable computer such as a tablet, a mobile communication device such as a mobile phone, etc. Target IM client 105 and communication client 115 will include appropriate client-side operational and application software. IM server 110 generally is implemented as a server type of computer system having appropriate server-side operational and application software.

In general, target IM client 105 includes IM agent 125 and IM application 130. User 135 is associated with target IM client 105 and, as such, is referred to as the “target user” from time-to-time within this specification. The phrase “target user” is used to refer to a user of an IM client that is disabled. A “user” refers to a human being that operates a data processing system and/or an application executing within the data processing system. When IM application 130 is executing within target IM client 105 and user 135 is logged into IM application 130, target IM client 105 is enabled to send and receive instant messages.

Communication client 115 can be implemented as, or be representative of, any of a variety of different devices. In one example, communication client 115 is an IM client. In another example, communication client 115 is an electronic mail client. In still another example, communication client 115 is a telephone, e.g., a Voice Over Internet Protocol (VOIP) phone. User 140 is associated with communication client 115 and is referred to as a source user from time-to-time within this specification. A source user refers to a user expressing an interest in contacting a user, e.g., a target user.

IM server 110 is configured, e.g., programmed, to distribute and/or route instant messages among various IM clients such as target IM client 105 and/or communication client 115. In one aspect, IM server 110 is configured to detect auto-start events. Responsive to detecting an auto-start event for target IM client 105 and/or user 135, IM server 110 sends a notification of the detected auto-start event to target IM client 105 and, more particularly, to IM agent 125.

In one aspect, IM agent 125 executes within target IM client 105 and listens for detected auto-start events from IM server 110. In another aspect, IM agent 125 detects auto-start events as opposed to being notified about detection of an auto-start event from IM server 110. In either case, responsive to a detected auto-start event, IM agent 125 enables target IM client 105.

In operation, target IM client 105 is executing IM agent 125. Target IM client 105 begins operation in a disabled state. When target IM client 105 is in a disabled state, target IM client 105 is not able to receive instant messages from other users such as user 140. In one example, target IM client 105 is disabled when IM application 130 is executing, but user 135 is not logged into IM application 130. In another example, target IM client 105 is disabled when IM application 130 is not executing within target IM client 105.

Responsive to detecting an auto-start event, IM agent 125 enables target IM client 105. In general, an auto-start event refers to one or more conditions that, when met or detected, indicate a user's desire to contact a target user, with the user expressing interest in contacting the target user being designated as the source user. Referring to FIG. 1, an auto-start event is the occurrence of one or more conditions indicating a desire of user 140 to contact user 135 while target IM client 105 is disabled. The conditions that are to be met indicating a detected auto-start event can define attributes of the source user (user 140), actions taken by the source user, and/or the status of target IM client 105.

Examples of actions that can be defined by conditions for an auto-start event include, but are not limited to, user 140 selecting an option from within communication client 115 to be alerted when user 135 becomes available or online through IM application 130, user 140 checking the online status of user 135 more than a minimum number of times within a predetermined amount of time while user 135 is unavailable at least to user 140 through IM application 130, and/or user 140 sending a message to user 135.

An example of user 140 sending a message to user 135 includes user 140 sending an electronic mail to user 135. In one aspect, the message must be sent using an option to send electronic mail from within an IM application executing within communication client 115. Another example of user 140 sending a message to user 135 is user 140 sending an electronic mail to user 135 in which the electronic mail has one or more required statuses and/or has one or more required statuses for at least a minimum amount of time. Examples of electronic mail status include, but are not limited to, urgent, not-urgent, unread, read, or combinations such as urgent and unread, urgent and read, etc. Accordingly, an illustrative example of an auto-start event is detecting that user 140 has sent an electronic mail to user 135 (which may or may not be required to be urgent) and that the electronic mail has an unopened status for at least the minimum amount of time. Another example includes user 140 calling user 135 and the call is not answered, user 140 leaving a voice mail for user 135, user 140 calling user 135 at least a minimum number of times within a predetermined amount of time, etc.

Examples of source user attributes that can be defined by conditions for an auto-start event include, but are not limited to, the identity of user 140, the role of user 140 within an organization, user 140 being a person that user 135 has designated on an auto-start list defining users whose actions are permitted to trigger an auto-start event for user 135, and/or user 140 being listed as a participant in a meeting in which user 135 is also a participant. An example of the role of user 140 is where user 140 is within the management chain of user 135, e.g., above user 135, as specified by an organizational chart or hierarchy.

In one aspect, the various conditions defining attributes of the source user are used to update the auto-start list dynamically. For example, responsive to user 140 being listed on a meeting in which user 135 is also a participant, e.g., user 140 accepting an invitation via a calendar system, user 140 is automatically added to the auto-start list for user 135. Responsive to user 140 being given a position in the management chain of user 135 and the user profile of user 140 being updated to indicate the position, user 140 is automatically added to the auto-start list of user 135.

Examples of the status, or state, of target IM client 105 can include, but are not limited to, target IM client 105 being disabled, target IM client 105, despite being disabled, having access to, e.g., being on, network 120, or any combination thereof.

The aforementioned conditions can be used individually or in any combination. For example, an auto-start event can be where user 140 is on the auto-start list for user 135 and has sent a minimum number, e.g., one or more, electronic mail(s) to user 135. In another example, the electronic mail sent by user 140, who is on the auto-start list of user 135, may need to have an urgent status and remain unopened for at least a minimum amount of time before being considered an auto-start event per the defined conditions.

The examples of auto-start events provided within this specification are intended as illustrations only and are not intended as limitations. As noted, an auto-start event defines conditions that, when met, indicate that a source user has expressed interest in communicating with a target user. The particular communication channels over which the desire to communicate may be expressed include, but are not limited to, IM, electronic mail, telephone (e.g., VOIP), or the like.

In any case, once an auto-start event is detected, IM agent 125 logs user 135 into IM application 130. In the event that IM application 130 is not already executing, IM agent 125 first launches, e.g., executes, IM application 130 within target IM client 105. Once user 135 is logged into IM application 130, target IM client 105 is enabled.

In one aspect, target IM client 105 is enabled in a particular operating mode that limits the users that are able to send instant messages to target IM client 105. In one aspect, the list of users permitted to send instant messages to target IM client 105, referred to as the “allowed user list,” is limited. For example, the allowed user list can be limited only to the source user. In another aspect, the allowed user list can be dynamically updated according to various rules.

FIG. 2 is a block diagram illustrating an example of target IM client 105 of FIG. 1. It should be appreciated that the architecture illustrated in FIG. 2 can be used in any of a variety of different form factors whether a desktop computer, a laptop or other portable computer such as a tablet, a mobile device, etc. Further, though described with reference to target IM client 105, it should be appreciated that the architecture described can be used to implement IM server 110 and/or communication client 115. Appreciably, different operational software and/or application software would be used when implementing IM server 110 as opposed to a client type of device.

Target IM client 105 includes at least one processor (e.g., a central processing unit) 205 coupled to memory elements 210 through a system bus 215 or other suitable circuitry. As such, target IM client 105 can store program code within memory elements 210. Processor 205 executes the program code accessed from memory elements 210 via system bus 215. In one aspect, for example, target IM client 105 is implemented as a computer or other programmable data processing apparatus that is suitable for storing and/or executing program code. It should be appreciated, however, that target IM client 105 can be implemented in the form of any system including a processor and memory that is capable of performing and/or initiating the functions and/or operations described within this specification.

Memory elements 210 can include one or more physical memory devices such as, for example, local memory 220 and one or more bulk storage devices 225. Local memory 220 refers to RAM or other non-persistent memory device(s) generally used during actual execution of the program code. Bulk storage device(s) 225 can be implemented as a hard disk drive (HDD), solid state drive (SSD), or other persistent data storage device. Target IM client 105 also can include one or more cache memories (not shown) that provide temporary storage of at least some program code in order to reduce the number of times program code must be retrieved from bulk storage device 225 during execution.

Input/output (I/O) devices such as a keyboard 230, a display 235, and a pointing device 240 optionally can be coupled to target IM client 105. The I/O devices can be coupled to target IM client 105 either directly or through intervening I/O controllers. One or more network adapters 245 also can be coupled to target IM client 105 to enable target IM client 105 to become coupled to other systems, computer systems, remote printers, and/or remote storage devices through intervening private or public networks. Modems, cable modems, Ethernet cards, and wireless transceivers are examples of different types of network adapters 245 that can be used with target IM client 105.

As pictured in FIG. 2, memory elements 210 store IM agent 125 and IM application 130. IM agent 125 and IM application 130, being implemented in the form of executable program code, can be executed by target IM client 105 and, as such, are considered an integrated part of target IM client 105. IM agent 125, IM application 130, and the various types of events and/or conditions described within this specification, whether detected within target IM client 105 and/or IM server 110, are functional data structures that impart functionality when employed as part of the relevant data processing system.

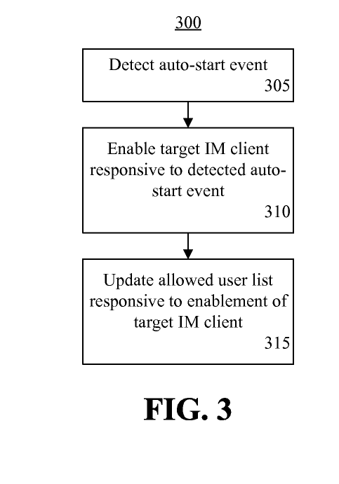

FIG. 3 is a flow chart illustrating an exemplary method 300 of communicating using IM technology. Method 300 can be performed by target IM client 105 as described with reference to FIGS. 1 and 2 of this specification. It should be appreciated, however, that one or more of the various operations described also can be performed by IM server 110 operating in cooperation with target IM client 105 as described in further detail below.

Method 300 can begin in a state where the target IM client is disabled. In block 305, an auto-start event for the target IM client is detected. In one aspect, the auto-start event is detected by the IM server and communicated to the IM client. As discussed, the IM agent can be executing within the target IM client and listen for detected auto-start events despite the target IM client being disabled.

For example, the IM server can be coupled to one or more other systems, e.g., electronic mail servers, telephone and/or VOIP servers, to detect the various conditions described defining auto-start events for the target IM client. In addition, the IM server, being communicatively linked with the communication client of the source user, can detect any queries initiated via the communication client by the source user for status of the target user or requested notifications of status for the target user such as when the target user becomes available and/or online.

In another aspect, e.g., where the target IM client detects the auto-start event, the IM agent can be configured to monitor the status of the target user's electronic mail, whether via accessing the electronic mail client application and/or accessing the electronic mail server, accessing the telephone system on behalf of the target user, or the like. In that case, the IM agent (and thus the target IM client) detects the auto-start event.

In block 310, the target IM client is enabled responsive to detecting the auto-start event. In one aspect, responsive to a notification of the detected auto-start event from the IM server, the IM agent enables the target IM client to receive instant messages. In another aspect, when the IM agent detects the auto-start event, the IM agent enables the target IM client to receive instant messages.

As discussed, enabling the target IM client includes logging the target user into the IM application executing within the IM client. It should be appreciated that logging the target user into the IM application further logs the target user into the IM server. As such, the target user establishes a presence with the IM server whether the target user is available or not to one or more other users also logged into the IM server. In the event the IM application is not already executing, the IM agent first launches or executes the IM application prior to logging the target user into the IM application.

In block 315, the target IM client updates the allowed user list, which specifies each user that is permitted to contact the target user through the target IM client. The allowed user list is updated responsive to the auto-start event and/or the IM client being enabled as described. By updating the allowed user list under such circumstances, the IM client is effectively enabled in a particular operating mode in which only those users on the allowed user list are permitted to send instant messages to the target user.

In one aspect, the allowed user list can include any users that would be permitted to send an instant message to the user under normal operating conditions. In another aspect, the allowed user list can be started fresh, e.g., with only those users that are added through the update process of block 315. In this regard, the allowed user list is dynamic in nature.

In one illustrative example, the allowed user list is initialized to include no other users except for the source user, e.g., only the source user. It should be appreciated that the source user is identifiable by the detected auto-start event and, as such, can be added to the allowed user list. Thus, in block 315, the allowed user list is updated to specify the source user. As discussed, the source user is the user that precipitated the auto-start event and/or initiated actions leading to detection of the auto-start event.

In another illustrative example, the allowed user list can be updated to include any users that are participants of a meeting to which the target user is also a participant. Further, the particular users that are added under such circumstances, e.g., being a participant of a meeting to which the target user is a participant, can be limited to only those users that are participants of a meeting that has started or is in progress, or for a meeting that is scheduled to occur within a minimum amount of time after enablement of the target IM client responsive to the auto-start event.

In still another example, the allowed user list can be updated to include any users that are within the managerial chain, e.g., above, the target user. In still another example, one or more other users that have been designated by the target user can be automatically added to the allowed user list.

It should be appreciated that the techniques described for updating the allowed user list are provided for purposes of illustration only and are not intended to be limiting. Any of a variety of different processing rules can be formulated and executed responsive to enabling the target IM client in response to a detected auto-start event.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method, comprising:
detecting an auto-start event for an instant messaging client, wherein the instant messaging client is disabled and associated with a target user;
enabling, using a processor, the instant messaging client responsive to detecting the auto-start event; and
updating a list of users permitted to contact the target user through the instant messaging client responsive to enabling the instant messaging client from the auto-start event.

2. The method of claim 1, wherein the auto-start event comprises a user sending a message other than an instant message to the target user while the instant messaging client is disabled.

3. The method of claim 2, wherein the message has a required status.

4. The method of claim 3, wherein the message has the required status for at least a minimum amount of time.

5. The method of claim 1, wherein the auto-start event comprises a user checking an availability status of the target user a minimum number of times within a predetermined time period while the instant messaging client is disabled.

6. The method of claim 1, wherein detecting the auto-start event comprises:
identifying an action indicating a user having an interest in communicating with the target user; and
determining at least one attribute of the user meets a condition required for detecting the auto-start event.

7. The method of claim 1, wherein enabling the instant messaging client comprises:
logging the user into an instant messaging application executing within the instant messaging client.

8. The method of claim 1, wherein the list of users permitted to contact the target user through the instant message client is updated so that only a user precipitating the auto-start event is on the list.

9. A system comprising:
a processor programmed to initiate executable operations comprising:
detecting an auto-start event for an instant messaging client, wherein the instant messaging client is disabled and associated with a target user;
enabling the instant messaging client responsive to detecting the auto-start event; and
updating a list of users permitted to contact the target user through the instant messaging client responsive to enabling the instant messaging client from the auto-start event.

10. The system of claim 9, wherein the auto-start event comprises a user sending a message other than an instant message to the target user while the instant messaging client is disabled.

11. The system of claim 10, wherein the message has a required status.

12. The system of claim 11, wherein the message has the required status for at least a minimum amount of time.

13. The system of claim 9, wherein the auto-start event comprises a user checking an availability status of the target user a minimum number of times within a predetermined time period while the instant messaging client is disabled.

14. The system of claim 9, wherein detecting the auto-start event comprises:
identifying an action indicating a user having an interest in communicating with the target user; and
determining at least one attribute of the user meets a condition required for detecting the auto-start event.

15. A computer program product comprising a computer readable storage medium having program code stored thereon, the program code executable by a processor to perform a method comprising:
detecting, using the processor, an auto-start event for an instant messaging client, wherein the instant messaging client is disabled and associated with a target user;
enabling, using the processor, the instant messaging client responsive to detecting the auto-start event; and
updating, using the processor, a list of users permitted to contact the target user through the instant messaging client responsive to enabling the instant messaging client from the auto-start event.

16. The computer program product of claim 15, wherein the auto-start event comprises a user sending a message other than an instant message to the target user while the instant messaging client is disabled.

17. The computer program product of claim 16, wherein the message has a required status.

18. The computer program product of claim 17, wherein the message has the required status for at least a minimum amount of time.

19. The computer program product of claim 15, wherein the auto-start event comprises a user checking an availability status of the target user a minimum number of times within a predetermined time period while the instant messaging client is disabled.

20. The computer program product of claim 15, wherein detecting the auto-start event comprises:
identifying an action indicating a user having an interest in communicating with the target user; and
determining at least one attribute of the user meets a condition required for detecting the auto-start event.
